(19) United States
(12) Patent Application Publication
(10) Pub. No.: US 2025/0246627 A1
(43) Pub. Date: Jul. 31, 2025

(54) NON-AQUEOUS ELECTROLYTE SECONDARY BATTERY

(71) Applicant: TOYOTA JIDOSHA KABUSHIKI KAISHA, Toyota-shi (JP)

(72) Inventor: Hiroshi TSUBOUCHI, Nagoya-shi (JP)

(73) Assignee: TOYOTA JIDOSHA KABUSHIKI KAISHA, Toyota-shi (JP)

(21) Appl. No.: 18/941,427

(22) Filed: Nov. 8, 2024

(30) Foreign Application Priority Data
Jan. 31, 2024 (JP) 2024-013642

(51) Int. Cl. H01M 4/62; H01M 4/02

(52) U.S. Cl. CPC H01M 4/621; H01M 2004/027

(57) ABSTRACT

A cathode, an anode, and a separator are provided, wherein the anode includes an anode current collector, an anode active material portion disposed on a surface of the anode current collector, and an insulating portion containing a ceramic disposed on the surface, and the insulating portion is 5% to 40% by volume with respect to the total volume of the anode after charging.

### CROSS-REFERENCE TO RELATED APPLICATION

This application claims priority to Japanese Patent Application No. 2024-013642 filed on Jan. 31, 2024, incorporated herein by reference in its entirety.

### BACKGROUND

### 1. Technical Field

The present disclosure relates to a non-aqueous electrolyte secondary battery.

### 2. Description of Related Art

A non-aqueous electrolyte secondary battery such as a lithium ion secondary battery includes a separator disposed between a cathode and an anode, and an electrolyte including a non-aqueous electrolyte. Regarding such a lithium ion secondary battery, Japanese Unexamined Patent Application Publication No. 2018-195572 (JP 2018-195572 A) discloses an anode current collector including a plurality of protrusions that protrudes toward a separator on its surface. The non-aqueous electrolyte secondary battery disclosed in JP 2018-195572 A uses the anode current collector including the protrusions. As a result, the distribution of the non-aqueous electrolyte is made uniform, and lithium metal is uniformly deposited on a portion of the anode current collector where the protrusions are not formed.

Thus, the non-aqueous electrolyte secondary battery disclosed in JP 2018-195572 A can improve the cycle life while maintaining the charging efficiency. The protrusion of the anode current collector is made of a conductive material other than lithium metal and a lithium alloy, or an insulating material such as polyolefin or polyimide.

### SUMMARY

The non-aqueous electrolyte secondary battery disclosed in JP 2018-195572 A has a problem of a decrease in energy density after a charge-discharge cycle. In view of the above circumstances, an object of an embodiment of the present disclosure is to provide a non-aqueous electrolyte secondary battery capable of maintaining a high energy density after a charge-discharge cycle.

The present disclosure that achieves the above object includes the following.
<1> A non-aqueous electrolyte secondary battery includes a cathode, an anode, and a separator disposed between the cathode and the anode.
The anode includes an anode current collector, an anode active material portion disposed on a surface of the anode current collector, and an insulating portion disposed on the surface and containing a ceramic.
The insulating portion is 5 vol % to 40 vol % with respect to a total volume of the anode after charging.
<2> In the non-aqueous electrolyte secondary battery according to <1>, the ceramic contained in the insulating portion may be alumina or Li₇La₃Zr₂O₁₂.
<3> In the non-aqueous electrolyte secondary battery according to <1> or <2>, the insulating portion may include the ceramic and a binder, and the ceramic may be 95 mass % or more with respect to a total of the ceramic and the binder.
<4> In the non-aqueous electrolyte secondary battery according to any one of <1> to <3>, the insulating portion may be a plurality of protrusions disposed on the surface of the anode current collector.
<5> In the non-aqueous electrolyte secondary battery according to <4>, the protrusion may have a columnar shape.

With the non-aqueous electrolyte secondary battery of the embodiment of the present disclosure, a high energy density can be maintained after the charge-discharge cycle. Since the high energy density is maintained even after repeated charging and discharging, the life of the secondary battery can be prolonged.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view of a portion including an anode and a separator, which is an embodiment of the non-aqueous electrolyte secondary battery of the present disclosure;

FIG. 2 is a schematic cross-sectional view of a portion including an anode and a separator, which is another aspect of the non-aqueous electrolyte secondary battery of the present disclosure;

FIG. 3 is a perspective view schematically illustrating a process of forming an insulating portion on an anode current collector in the non-aqueous electrolyte secondary battery of the present disclosure; and

FIG. 4 is a characteristic diagram showing the relationship between the volume ratio of the insulating portion with respect to the entire anode and the energy density ratio after the cycle test, for Examples and Comparative Examples.

### DETAILED DESCRIPTION OF EMBODIMENTS

Hereinafter, an embodiment of the present disclosure will be described. The description is illustrative of the embodiments and is not intended to limit the scope of the disclosure.

In the present specification, a numerical range indicated by using “from” indicates a range including the numerical values described before and after “from” as the minimum value and the maximum value, respectively.

In the numerical ranges described in the present specification in a stepwise manner, the upper limit value or the lower limit value described in one numerical range may be replaced with the upper limit value or the lower limit value of the numerical range described in another stepwise manner. In addition, in the numerical range described in the present specification, the upper limit value or the lower limit value of the numerical range may be replaced with the value shown in the examples.

In the present specification, when an embodiment is described with reference to the drawings, the configuration of the embodiment is not limited to the configuration shown in the drawings. In addition, the sizes of the members in the drawings are conceptual, and the relative relationships of the sizes between the members are not limited thereto.

In the present specification, each component may include a plurality of corresponding substances. When the amount of each component in the composition is referred to in the present embodiment, when a plurality of substances corresponding to each component are present in the composition, the total amount of the plurality of substances present in the composition is meant unless otherwise specified.

The non-aqueous electrolyte secondary battery of the present disclosure includes:
A cathode, an anode, and a separator disposed between the cathode and the anode,
The anode includes an anode current collector, an anode active material portion disposed on a surface of the anode current collector, and an insulating portion containing a ceramic disposed on the surface.
   The insulating portion may have a volume percentage of 5% to 40% with respect to the total volume of the anode after charging.

The non-aqueous electrolyte secondary battery of the present disclosure can suppress a decrease in energy density after a charge-discharge cycle, and thus can achieve a long life such that a high energy density can be maintained even after repeated charge-discharge.

In the non-aqueous electrolyte secondary battery of the present disclosure, the ceramic is included in the insulating portion disposed on the surface of the anode current collector. Since the insulating portion is 5% by volume to 40% by volume with respect to the total volume of the anode after charging, the dielectric property of the ceramic promotes ion transfer at the lithium metal deposition interface. Therefore, in the non-aqueous electrolyte secondary battery of the present disclosure, a uniform lithium metal deposition reaction is possible, and the lithium metal to be deposited is suppressed from becoming porous. In the non-aqueous electrolyte secondary battery of the present disclosure, the lithium metal deposited on the anode current collector functions as an anode active material. Through such a mechanism, it is presumed that the non-aqueous electrolyte secondary battery of the present disclosure can maintain a high energy density even after repeated charging and discharging. If the insulating portion disposed on the surface of the anode current collector does not have a ceramic, the deposited lithium metal becomes porous, resulting in a decrease in energy density due to repeated charging and discharging. Further, if the insulating portion deviates from the range of 5% by volume to 40% by volume with respect to the total volume of the anode after charging, the lithium metal deposited becomes porous, resulting in a decrease in energy density due to repeated charge and discharge.

In addition, in the non-aqueous electrolyte secondary battery of the present disclosure, the ceramic is included in the insulating portion disposed on the surface of the anode current collector. The insulating portion is 5% by volume to 40% by volume with respect to the total volume of the anode after charging. Therefore, deformation of the insulating portion due to expansion of the insulating portion due to penetration of the non-aqueous electrolyte solution or stress caused by lithium metal deposition hardly occurs, it is possible to suppress a decrease in energy density due to an increase in volume of the insulating portion. If the insulating portion disposed on the surface of the anode current collector does not have a ceramic, the swelling or deformation of the insulating portion caused by repeated charging and discharging leads to a decrease in energy density. Further, if the insulating portion falls outside the range of 5% by volume to 40% by volume with respect to the total volume of the anode after charging, the swelling or deformation of the insulating portion caused by repeated charging and discharging, resulting in a decrease in energy density.

In the non-aqueous electrolyte secondary battery of the present disclosure, as described above, the range of the volume ratio (volume %) of the insulating portion with respect to the total volume of the anode after charging is set to 5 volume % to 40 volume %, but in particular, it is preferably 9 volume % to 36 volume %. It is more preferably from 17% to 26% by volume, still more preferably from 20% to 25% by volume, and most preferably 23% by volume.

### Anode Current Collector

The anode current collector is not particularly limited, and an anode current collector conventionally used in manufacturing an anode can be used. The anode current collector is not particularly limited, and examples thereof include Cu, Ni, Cr, Au, Pt, Ag, Al, Fe, Ti, Zn, Co and stainless-steel, and Cu is preferable. The thickness of the anode current collector is not particularly limited, and may be, for example, 0.1 μm to 1 mm. As the anode current collector, a strip-shaped current collector having a foil shape, a perforated foil shape, a mesh shape, or the like can be used.

### Insulating Portion

In the non-aqueous electrolyte secondary battery of the present disclosure, the ceramic included in the insulating portion has an insulating property (preferably, a volume resistivity ≥10⁶ Ω·m), and a non-metallic inorganic material produced through firing can be widely used. Examples of the ceramic include alumina (Al₂O₃), sapphire (Al₂O₃), zirconium oxide (ZrO₂), barium titanate (BaTiO₃), aluminum nitride (AlN), silicon nitride (Si₃N₄), boron nitride (BN), cordierite (2MgO·2Al₂O₃·5SiO₂), steatite (MgO·SiO₂), forsterite (2MgO·SiO₂), yttria (Y₂O₃), silicon dioxide (SiO₂), magnesium oxide (MgO), and bismuth oxide (III) (Bi₂O₃). These ceramics may be used singly or in combination as the material of the insulating portion. Among these ceramics, it is particularly preferable to use alumina.

As the ceramic included in the insulating portion, a ceramic having a high relative dielectric constant is preferably used. The ceramic having a high relative dielectric constant is not particularly limited, but a solid electrolyte can be used without limitation. As such solid electrolytes, crystalline nitrides, oxides, sulfides, and oxoacids, as well as non-crystalline glass structured materials can be used. Specific examples of sulfide solid electrolytes that can be used as the solid electrolytes include at least one selected from the group consisting of LiI-LiBr-Li₃PS₄, Li₂S-SiS₂, LiI-Li₂S-SiS₂, LiI-Li₂S-P₂S₅, LiI-Li₂O-Li₂S-P₂S₅, LiI-Li₂S-P₂O₅, LiI-Li₃PO₄-P₂S₅, Li₂S-P₂S₅, Li₃PS₄, LiCl-LiBr-Li₃PS₄, LiCl-LiBr-Li₂S-P₂S₅, and LiCl-LiBr-Li₂S-SiS₂. In addition, examples of oxide solid electrolytes include Li_{0.34}La_{0.56}TiO₃, Li_{3/8}Sr_{7/16}Ta_{3/4}M_{1/4}O₃ (M=Zr or Hf), Li₇La₃Zr₂O₁₂, Li_{1.3}Al_{0.7}Ti_{1.3}(PO₄)₃, Li_{1.5}Al_{0.5}Ge_{1.5}(PO₄)₃, Li_{3.5}Ge_{0.5}V_{0.5}O, Li_{2.88}PO_{3.73}N_{0.14}, and Li_{2.9}Si_{0.45}PO_{1.6}N_{1.3}. In addition to these, a complex hydride-based lithium ion conductor or a halide-based lithium ion conductor may be used as the solid electrolyte. One kind or a plurality of kinds selected from these can be combined and used as a ceramic included in an insulating portion of the non-aqueous electrolyte secondary battery according to the present disclosure. Among these ceramics, Li₇La₃Zr₂O₁₂(LLZO) is preferably used.

The insulating portion described above is disposed on the surface of the anode current collector. When the surface of the anode current collector is observed from above, the insulating portion may have either a strip shape or an island shape. In addition, the surface of the anode current collector may have a strip shape including a curve when viewed from above, or may have an island shape having a circular shape or a polygonal shape when viewed from above.

The insulating portion in the non-aqueous electrolyte secondary battery of the present disclosure can be formed into a slurry by mixing the above-described ceramic with a binder, and can be formed as a desired shape on the surface of the anode current collector using the slurry. At this time, the amount of the ceramic contained in the insulating portion is not particularly limited, but may be, for example, 70 mass % or more with respect to the total of the ceramic and the binder. The content is preferably 75% by mass or more, more preferably 80% by mass or more, further preferably 85% by mass or more, further preferably 90% by mass or more, and most preferably 95% by mass or more. The amount of the ceramic contained in the insulating portion may be 99.5% by mass. By setting the amount of ceramic contained in the insulating portion within this range, it is possible to reliably suppress the lithium metal from becoming porous, and to reliably suppress the volume increase of the insulating portion, and to more reliably maintain a high energy density even after repeated charging and discharging.

The binder is not particularly limited, and examples thereof include butadiene rubber (BR), butylene rubber (IIR), acrylate butadiene rubber (ABR), styrene-butadiene rubber (SBR), polyvinylidene fluoride (PVdF), and polyvinylidene fluoride-hexafluoropropylene copolymer (PVdF-HFP).

### Anode Active Material Portion

In the non-aqueous electrolyte secondary battery of the present disclosure, the anode active material portion is disposed on the surface of the anode current collector. The anode active material portion is made of lithium metal deposited on the surface of the anode current collector. The lithium metal is deposited on the surface of the anode current collector by assembling a non-aqueous electrolyte secondary battery to be described later using the anode current collector having the insulating portion described above and then charging the non-aqueous electrolyte secondary battery.

Hereinafter, an embodiment of a non-aqueous electrolyte secondary battery of the present disclosure will be described with reference to the drawings.

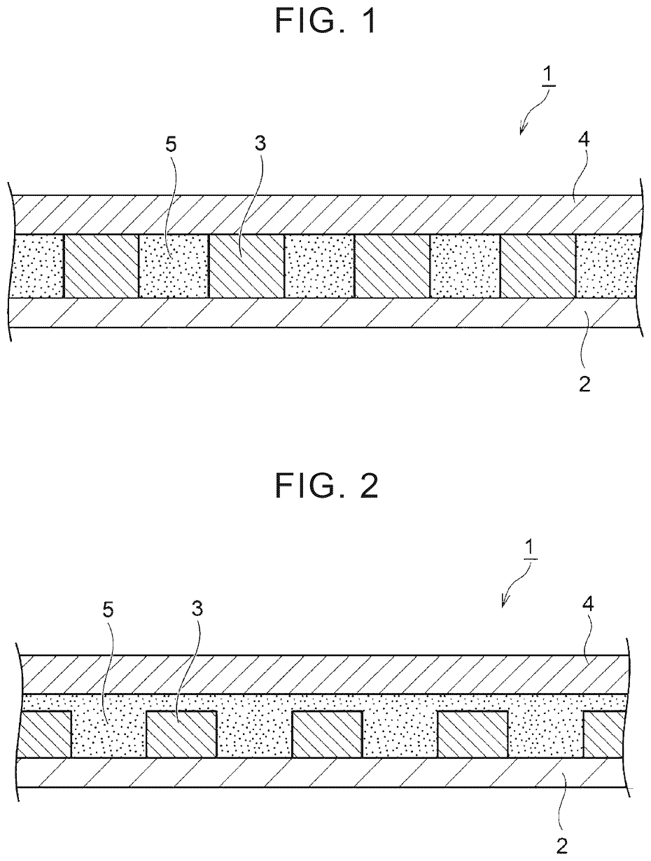

FIG. 1 and FIG. 2 are cross-sectional views of a portion including an anode and a separator in the non-aqueous electrolyte secondary battery of the present disclosure. That is, the non-aqueous electrolyte secondary battery 1 illustrated in FIGS. 1 and 2 includes an anode current collector 2, insulating portions 3 disposed on one main surface of the anode current collector 2, and an anode active material portion 5 disposed on the same one main surface of the anode current collector 2. In the non-aqueous electrolyte secondary battery 1 shown in FIGS. 1 and 2, the anode and the cathode (not shown) face each other via the separator 4.

In particular, in the non-aqueous electrolyte secondary battery 1 illustrated in FIGS. 1 and 2, the insulating portions 3 are formed as a plurality of protrusions on the surface of the anode current collector 2. The insulating portions 3 formed as the plurality of protrusions are arranged at regular intervals at predetermined intervals. That is, in the non-aqueous electrolyte secondary battery 1 shown in FIGS. 1 and 2, the insulating portions 3 are formed in a columnar shape on one main surface of the anode current collector 2.

In particular, in the non-aqueous electrolyte secondary battery 1 shown in FIG. 1, the upper surfaces of the insulating portions 3 are in contact with the separator 4. In this case, the anode active material portion 5 is made of lithium metal deposited between the insulating portions 3 formed as the plurality of protrusions. In the non-aqueous electrolyte secondary battery 1 shown in FIG. 2, the upper surfaces of the insulating portions 3 are separated from the separator 4. In this case, the anode active material portion 5 is made of lithium metal deposited so as to fill the space between the insulating portions 3 formed as the plurality of protrusions and the space between the insulating portions 3 and the separator 4.

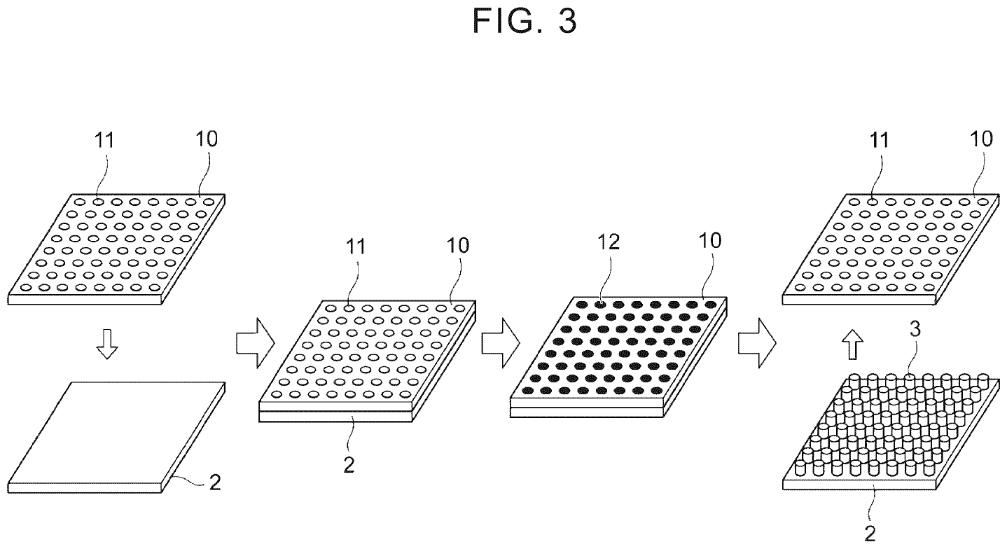

In the non-aqueous electrolyte secondary battery 1 shown in FIGS. 1 and 2, the method schematically shown in FIG. 3 can be applied to form the insulating portions 3 on the surface of the anode current collector 2. FIG. 3 shows a procedure of forming the insulating portions 3 from left to right. That is, first, the perforated foil 10 placed on one main surface of the anode current collector 2 is prepared. The perforated foil 10 is a foil having a thickness corresponding to the height of the insulating portions 3, and a plurality of through holes 11 corresponding to the shape of the insulating portions 3 are formed. Then, the perforated foil 10 is placed on one main surface of the anode current collector 2. In this state, the slurry 12 in which the above-described ceramic is mixed with the binder is applied to the upper surface of the perforated foil 10, and the slurry 12 is filled in the through holes 11. Thereafter, the perforated foil 10 is peeled from the anode current collector 2 and dried, whereby the insulating portions 3 corresponding to the through holes 11 can be formed on one main surface of the anode current collector 2.

### Non-Aqueous Electrolyte Secondary Battery

The non-aqueous electrolyte secondary battery of the present disclosure includes an anode including the above-described insulating portion. The non-aqueous electrolyte secondary battery may include the above-described anode, a cathode, a separator disposed between the anode and the cathode, and a non-aqueous electrolyte. In the secondary battery of the present disclosure, the cathode, the separator, and the non-aqueous electrolytic solution are not particularly limited, and conventionally known ones can be applied.

The cathode can be obtained by forming a cathode mixture portion on the surface of the cathode current collector. As the non-aqueous electrolyte, a so-called organic electrolyte can be used in which, for example, a lithium salt that is an electrolyte such as Li(FSO₂)₂N, LiClO₄, LiPF₆, LiAsF₆, LiBF₄, LiSO₃CF₃ is dissolved in a non-aqueous solvent of a single substance or a mixture of two or more components such as ethylene carbonate, propylene carbonate, butylene carbonate, vinylene carbonate, fluoroethylene carbonate, cyclopentanone, sulfolane, 3-methylsulfolane, 2,4-dimethylsulfolane, 3-methyl-1,3-oxazolidin-2-one, γ-butyrolactone, dimethyl carbonate, diethyl carbonate, ethyl methyl carbonate, methyl propyl carbonate, butyl methyl carbonate, ethyl propyl carbonate, butyl ethyl carbonate, dipropyl carbonate, 1,2-dimethoxyethane, tetrahydrofuran, 2-methyltetrahydrofuran, 1,3-dioxolane, methyl acetate, and ethyl acetate.

The structure of the secondary battery of the present disclosure is not particularly limited, and generally, the cathode, the separator, and the anode are wound in a flat spiral shape to form a wound electrode plate group. Alternatively, the cathode, the separator, and the anode are laminated as a flat plate to form a laminated electrode plate group. In general, these electrode plate groups are enclosed in an exterior body. The secondary cells of this disclosure are used as paper-type, button-type, coin-type, laminated, cylindrical, angular, etc., but not limited to.

Hereinafter, the present disclosure will be described in more detail with reference to Examples, but the technical scope of the present disclosure is not limited to the following Examples.

### EXAMPLE 1

### Preparation of Anode

In this example, an insulating portion was formed on one main surface of the anode current collector foil in accordance with the procedure schematically illustrated in FIG. 3. Specifically, a circular through-hole having a diameter of 500 μm was patterned in a copper foil having a thickness of 30 μm, and a perforated foil having a through-hole was produced by etching. Alumina and binder (polyvinylidene fluoride (PVdF)) were mixed in solvents (N-methyl-2-pyrrolidone (NMP)) to a volume ratio of 99.5:0.5. Thus, a slurry for producing an insulating portion was prepared.

Then, a perforated foil was placed on one side of the electrolytic copper foil having a thickness of 10 μm. In this state, the slurry was applied to the perforated foil, whereby the slurry was filled in the through-hole formed in the perforated foil. Thereafter, the perforated foil was removed from the electrolytic copper foil, and the insulating portion formed on the electrolytic copper foil was dried. As described above, the anode current collector having the insulating portion was manufactured as an anode.

### Preparation of Test Cells

In this embodiment, a slurry for a cathode was prepared by mixing LiNi_{0.5}Co_{0.2}Mn_{0.3}O₂ as a cathode active material, acetylene black as a conductive auxiliary agent, and PVdF as a binder. The slurry for the cathode was applied to an aluminum foil (thickness: 15 μm) and pressed to prepare a cathode. Then, the cathode and the anode prepared as described above were opposed to each other with separators (polyethylenes) interposed therebetween, and were accommodated in a laminated film together with an electrolyte solution (4MLiFSI/DME solution) to prepare a test cell. In the test cell manufactured in this example, the insulating portion was 9% by volume with respect to the total volume of the anode after activation of the cell described later, that is, after charging.

### Cycle Test

The test cell fabricated as described above was activated with a current density of 0.4 mA/cm² and a voltage ranging from 3.0 V to 4.3 V. Lithium metal was deposited on the anode current collector by cell activation. Then, a 20-cycle test was performed with a current density of 3.0 V to 4.3 V in 1 mA/cm². The value obtained by dividing the capacity by the apparent volume of the anode after charging was defined as the electrode energy density after cycling. A value obtained by dividing the measured post-cycle electrode energy density by the post-cycle electrode energy density in the test cell manufactured in Comparative Example 1 described later was defined as the post-cycle electrode energy density ratio.

### EXAMPLES 2 to 5

In Example 1, a test cell was prepared in the same manner as in Example 1, except that the volume ratio of the insulating portion to the entire anode was prepared by adjusting the size and/or the number of the through-holes in the perforated foil, and the energy density after the cycle test was measured. For Examples 2 to 5, the electrode energy density ratio after cycling was also calculated in the same manner as in Example 1.

### EXAMPLE 6

In Example 1, except that Li₇La₃Zr₂O₁₂(LLZO) was used instead of alumina, and the volume ratio of the insulating portion to the entire anode was set to 20 vol %, a test cell was prepared in the same manner as in Example 1, and the energy density after the cycling test was measured. In Example 6, the electrode energy density ratio after cycling was also calculated in the same manner as in Example 1.

### Comparative Example 1

In Comparative Example 1, a test cell was prepared in the same manner as in Example 1 except that an electrolytic copper foil having a thickness of 10 μm was used instead of the anode current collector having an insulating portion, and the energy density after the cycle test was measured. By definition, the post-cycle electrode energy density ratio calculated for the test cell of Comparative Example 1 is 1.000.

### Comparative Example 2

In Example 1, a test cell was prepared in the same manner as in Example 1, except that the volume ratio of the insulating portion to the entire anode was set to 45% by volume by adjusting the size and/or the number of the through-holes in the perforated foil, and the energy density after the cycle test was measured. In Comparative Example 2, the electrode energy density ratio after cycling was calculated in the same manner as in Example 1.

### Comparative Example 3

In Example 1, a test cell was prepared in the same manner as in Example 1, except that polyimide (PI) was used instead of alumina and the volume ratio of the insulating portion to the entire anode was set to 20% by volume, and the energy density after the cycling test was measured. In Comparative Example 3, the electrode energy density ratio after cycling was also calculated in the same manner as in Example 1.

### Results

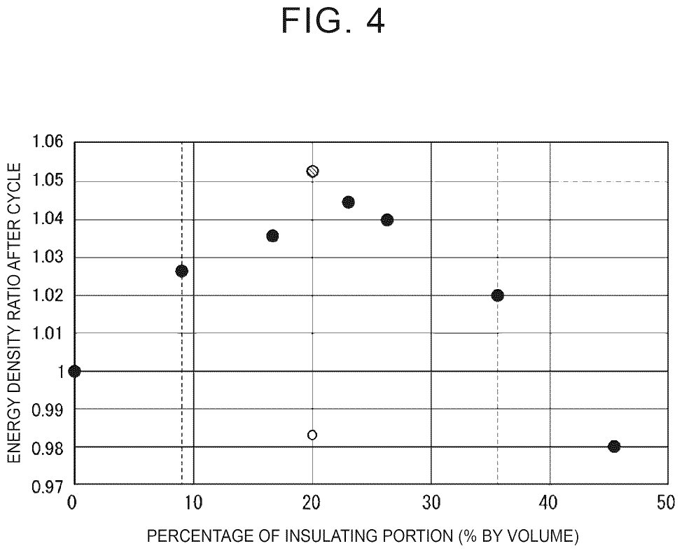

The results for Examples 1 to 6 and Comparative Examples 1 to 3 are shown in Table 1 and FIG. 4. In FIG. 4, black circles represent Comparative Example 1, Examples 1 to 5, and Comparative Example 2, shaded circles represent Example 6, and open circles represent Comparative Example 3. In FIG. 4, the vertical axis represents the energy density ratio after cycling, and the horizontal axis represents the volume % of the insulating portion with respect to the entire anode.

TABLE 1

| | Insulating | Volume % of | Energy density |
|---|---|---|---|
| | portion | insulating portion | ratio after cycle |
| Comparative | — | 0 | 1.000 |
| Example 1 | | | |
| Example 1 | Alumina | 9 | 1.027 |
| Example 2 | Alumina | 17 | 1.036 |
| Example 3 | Alumina | 23 | 1.045 |
| Example 4 | Alumina | 26 | 1.040 |
| Example 5 | Alumina | 36 | 1.020 |
| Comparative | Alumina | 45 | 0.980 |
| Example 2 | | | |
| Example 6 | LLZO | 20 | 1.053 |
| Comparative | PI | 10 | 0.983 |
| Example 3 | | | |

As shown in Table 1 and FIG. 4, in the anode having an insulating portion containing ceramic, the insulating portion has an insulating portion of 9% by volume to 36% by volume with respect to the total volume of the anode after charging. In this case, it was found that the energy density after the cycle test can be maintained high. In addition, it has been found that, in particular, when Li₇La₃Zr₂O₁₂(LLZO) having a higher relative dielectric constant is used as the ceramics, the energy density after the cycling test can be maintained higher.

What is claimed is:

1. A non-aqueous electrolyte secondary battery comprising a cathode, an anode, and a separator disposed between the cathode and the anode, wherein
the anode includes an anode current collector, an anode active material portion disposed on a surface of the anode current collector, and an insulating portion disposed on the surface and containing a ceramic, and
the insulating portion is 5 vol % to 40 vol % with respect to a total volume of the anode after charging.

2. The non-aqueous electrolyte secondary battery according to claim 1, wherein the ceramic contained in the insulating portion is alumina or Li₇La₃Zr₂O₁₂.

3. The non-aqueous electrolyte secondary battery according to claim 1, wherein the insulating portion includes the ceramic and a binder, and the ceramic is 95 mass % or more with respect to a total of the ceramic and the binder.

4. The non-aqueous electrolyte secondary battery according to claim 1, wherein the insulating portion is a plurality of protrusions disposed on the surface of the anode current collector.

5. The non-aqueous electrolyte secondary battery according to claim 4, wherein the protrusion has a columnar shape.
